(19) United States
(12) Patent Application Publication
(10) Pub. No.: US 2026/0214685 A1
(43) Pub. Date: Jul. 23, 2026

(54) METHODS, DEVICES AND COMPUTER STORAGE MEDIA OF COMMUNICATION

(71) Applicant: NEC Corporation, Tokyo (JP)

(72) Inventors: You LI, Beijing (CN); Minghui XU, Beijing (CN); Gang WANG, Beijing (CN)

(73) Assignee: NEC Corporation, Tokyo (JP)

(21) Appl. No.: 19/144,081

(22) PCT Filed: Dec. 28, 2022
(86) PCT No.: PCT/CN2022/142993

§ 371 Date: Jun. 27, 2025

(51) Int. Cl. H04W 72/25; H04L 1/00; H04W 68/02; H04W 76/20; H04W 76/30

(52) U.S. Cl. CPC H04W 72/25; H04L 1/0061; H04W 68/02; H04W 76/20; H04W 76/30

(57) ABSTRACT

Example embodiments of the present disclosure relate to a method of communication comprising: receiving, at a repeater device and from a network device, a radio resource control (RRC) release message for transitioning the repeater device into an inactive state; receiving, from the network device, a message for updating side control information (SCI) to be used by the repeater device in the inactive state; and performing a communication with at least one of the network device or a terminal device by using the updated SCI.

### TECHNICAL FIELD

Embodiments of the present disclosure generally relate to the field of telecommunication, and specifically relate to methods, devices, and computer storage media of communication.

### BACKGROUND

Coverage is a fundamental aspect of cellular network deployments. Mobile operators rely on different types of network nodes (or network devices) to offer blanket coverage in their deployments. Deployment of regular full-stack cells is one option, but it may not be always possible (for example, due to no availability of backhaul) or economically viable. Radio frequency (RF) repeaters as a new type of network nodes have been widely deployed to supplement the coverage provided by regular full-stack cells. An RF repeater generally performs amplify-and-forward operations without considering various factors that could improve performance. A network-controlled repeater (NCR) is an enhancement over RF repeaters. The NCR has the capability to receive and process side control information (SCI) from a network to improve the amplify-and-forward operations.

Further, power consumption is always a focus in current wireless communication system. In order to reduce power consumption, it is proposed that the device may be configured in some power saving modes/states (such as, inactive state). In case of the inactive state, normal data transmissions and part of the signalling transmissions are proposed to be suspended. Recently, it is proposed that the NCR may be transitioned into the inactive state. However, in case of the inactive state, if the NCR fails to determine/update the SCI information, the communication between the network device and the terminal device would be disturbed.

### SUMMARY

In general, embodiments of the present disclosure provide devices, methods, and computer storage media of communication.

In a first aspect, there is provided a repeater device. The repeater device comprises: a processor configured to cause the repeater device to: receive, from a network device, a radio resource control (RRC) release message for transitioning the repeater device into an inactive state; receive, from the network device, a message for updating SCI to be used by the repeater device in the inactive state; and perform a communication with at least one of the network device or a terminal device by using the updated SCI.

In a second aspect, there is provided a repeater device. The repeater device comprises: a processor configured to cause the repeater device to: detect a beam failure on a control link between the repeater device and a network device; and during a beam failure recovery (BFR), determine a forwarding function of the repeater device to be OFF.

In a third aspect, there is provided a repeater device. The repeater device comprises: a processor configured to cause the repeater device to: receive, from a network device, a configuration indicating resources to be used for a communication between the repeater device and a terminal device; receive, from the network device, an RRC release message for transitioning the repeater device into an inactive state; after transitioning into the inactive state, perform at least one of the following: in case that the resources are periodic resources, maintaining availability of the resources; or in case that the resources are aperiodic resources, maintaining the availability of the resources or invaliding the resources.

In a fourth aspect, there is provided a repeater device. The repeater device comprises: a processor configured to cause the repeater device to: receive, from a network device, an RRC release message for transitioning the repeater device into an inactive state; and determine a backhaul beam for a backhaul link between the repeater device and the network device based on a control beam for a control link between the repeater device and the network device, the control beam being indicated by the RRC release or determined by the repeater device.

In a fifth aspect, there is provided a network device. The network device comprises: a processor configured to cause the network device to: transmit, to a repeater device, an RRC release message for transitioning the repeater device into an inactive state; and transmit, to the repeater device, a message for updating SCI to be used by the repeater device in the inactive state.

In a sixth aspect, there is provided a network device. The network device comprises: a processor configured to cause the network device to: generate, an RRC release message for transitioning a repeater device into an inactive state, the RRC release message indicating at least one beam to be used by the repeater device in case that the repeater device is in the inactive state; and transmit, the RRC release message to the repeater device.

In a seventh aspect, there is provided a communication method. The method comprises: receiving, at a repeater device and from a network device, a radio resource control (RRC) release message for transitioning the repeater device into an inactive state; receiving, from the network device, a message for updating SCI to be used by the repeater device in the inactive state; and performing a communication with at least one of the network device or a terminal device by using the updated SCI.

In an eighth aspect, there is provided a communication method. The method comprises: detecting, at a repeater device, a beam failure on a control link between the repeater device and a network device; and during a beam failure recovery (BFR), determining a forwarding function of the repeater device to be OFF.

In a ninth aspect, there is provided a communication method. The method comprises: receiving, at a repeater device and from a network device, a configuration indicating resources to be used for a communication between the repeater device and a terminal device; receiving, from the network device, an RRC release message for transitioning the repeater device into an inactive state; after transitioning into the inactive state, performing at least one of the following: in case that the resources are periodic resources, maintaining availability of the resources; or in case that the resources are aperiodic resources, maintaining the availability of the resources or invaliding the resources.

In a tenth aspect, there is provided a communication method. The method comprises: receiving, at a repeater device and from a network device, an RRC release message for transitioning the repeater device into an inactive state; and determining a backhaul beam for a backhaul link between the repeater device and the network device based on a control beam for a control link between the repeater device and the network device, the control beam being indicated by the RRC release or determined by the repeater device.

In an eleventh aspect, there is provided a communication method. The method comprises: transmitting, at a network device, to a repeater device, an RRC release message for transitioning the repeater device into an inactive state; and transmitting, to the repeater device, a message for updating SCI to be used by the repeater device in the inactive state.

In a twelfth aspect, there is provided a communication method. The method comprises: generating, at a network device, an RRC release message for transitioning a repeater device into an inactive state, the RRC release message indicating at least one beam to be used by the repeater device in case that the repeater device is in the inactive state; and transmitting, the RRC release message to the repeater device.

In a thirteenth aspect, there is provided a computer readable medium having instructions stored thereon, the instructions, when executed on at least one processor, causing the at least one processor to carry out the method according to the first, second, third, fourth, fifth, or sixth aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features, and advantages of the present disclosure will become more apparent, wherein:

FIG. 1 illustrates a schematic diagram of an example communication network in which some embodiments of the present disclosure can be implemented;

FIG. 2 illustrates a signaling chart illustrating process of communication according to some example embodiments of the present disclosure;

FIGS. 3A to 3C illustrate signaling charts illustrating process of communication according to some example embodiments of the present disclosure;

FIG. 4 illustrates a signaling chart illustrating process of communication according to some example embodiments of the present disclosure;

FIG. 5 illustrates a signaling chart illustrating process of communication according to some example embodiments of the present disclosure;

FIG. 6 illustrates examples for handling the resource;

FIG. 7 illustrates a flowchart of a method implemented at a repeater device according to some example embodiments of the present disclosure;

FIG. 8 illustrates a flowchart of a method implemented at a repeater device according to some example embodiments of the present disclosure;

FIG. 9 illustrates a flowchart of a method implemented at a repeater device according to some example embodiments of the present disclosure;

FIG. 10 illustrates a flowchart of a method implemented at a repeater device according to some example embodiments of the present disclosure;

FIG. 11 illustrates a flowchart of a method implemented at a network device according to some example embodiments of the present disclosure;

FIG. 12 illustrates a flowchart of a method implemented at a network device according to some example embodiments of the present disclosure; and

FIG. 13 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/Ipv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device.

In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the term “repeater device” refers to a device which can provide an amplify-and-forward function between a terminal device and a network device, especially, the terminal device may be out of coverage of the network device or may be blocked from a communication with the network device. In some embodiments, the repeater device may receive control information from the network device to enhance the amply-and-forward function. Examples of the repeater device may include, but not be limited to, an NCR and the like. For the purposes of discussion, some embodiments of the present disclosure will be discussed by taking an NCR as the example of the repeater device.

In some embodiments, the repeater device may comprise a control function (also may be referred to as a control function entity) and a forwarding function (also may be referred to as a forwarding function entity). The control function communicates with a network device via a control link (C-link), for example, to receive the control information. The forwarding function performs amplify-and-forwarding of downlink (DL)/uplink (UL) RF signals between a network device and a terminal device via a backhaul link and an access link. The control and forwarding functions may be implemented as hardware, firmware, and/or algorithm-based software components of the repeater device and may be collocated or apart from each other. Examples of the control and forwarding functions may include, but not be limited to, an NCR mobile termination (NCR-MT) and an NCR forwarding (NCR-Fwd). For the purposes of discussion, some embodiments of the present disclosure will be discussed by taking the NCR-MT and NCR-Fwd as examples of the control and forwarding functions of the repeater device.

As used herein, the term “resource,” “transmission resource,” “forwarding resource,” “access resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

The terminal device, the network device and the repeater device may have Artificial intelligence (AI) or Machine learning capability. It generally includes a model which has been trained from numerous collected data for a specific function and can be used to predict some information.

The terminal or the network device may work on several frequency ranges, e.g., FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex, and cross division duplex modes.

The embodiments of the present disclosure may be performed in test equipment, e.g., signal generator, signal analyzer, spectrum analyzer, network analyzer, test terminal device, test network device, channel emulator.

In some embodiments, the terminal device may be connected to a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms “a,” “an” and “the” are intended to include the plural forms as well, unless the context clearly indicates otherwise. The term “includes” and its variants are to be read as open terms that mean “includes, but is not limited to.” The term ‘based on’ is to be read as “at least in part based on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As discussed above, coverage is a fundamental aspect of cellular network deployments. However, deployment of regular full-stack cells may not be always possible or economically viable. New types of nodes have been considered to increase flexibility of mobile operators for network deployments. For example, an IAB may be used as a new type of nodes not requiring a wired backhaul to provide coverage enhancement.

Another type of nodes is an RF repeater which may amplify-and-forward any received signal. There may have been a wide range of deployments of RF repeaters in the second generation (2G), the third generation (3G) and the fourth generation to supplement the coverage provided by regular full-stack cells. RF and electro magnetic compatibility (EMC) requirements may be designed for the RF repeaters in new radio (NR) targeting both FR1 and FR2.

An RF repeater presents cost effective means of extending the network coverage. However, generally, an RF repeater may simply perform amplify-and-forward operations without being able to consider various factors that could improve performance. Such factors may include information on semi-static and/or dynamic DL/UL configurations, adaptive transmitter/receiver spatial beamforming, ON-OFF status, and/or the like.

In the present disclosure, in case of OFF status, the repeater device (NCR, forwarding function of an NCR, NCR-Fwd) is not expected to perform forwarding. Alternatively, ON status means the opposite.

An NCR is an enhancement over RF repeaters with simple amplify-and-forward functions. The NCR has the capability to receive and process the SCI from a network. The SCI may allow an NCR to perform the amplify-and-forward operations in a more efficient manner. Potential benefits may include mitigation of unnecessary noise amplification, transmissions and receptions with better spatial directivity, and simplified network integration, and/or the like.

An NCR may include an NCR-MT and an NCR-Fwd. The NCR-MT may function as an entity or module to communicate with a network device (such as a gNB) via a C-link or control link to enable exchanges of information (such as, the SCI) between the network device and the NCR. The C-link may be based on an NR Uu interface. Further, the SCI is used at least for the control of NCR-Fwd. The NCR-Fwd may function as an entity or module to perform amplify-and-forwarding of UL/DL RF signals between the network device and a terminal device (such as a UE) via a backhaul link and an access link. Behaviors of the NCR-Fwd may be controlled according to the SCI received by the NCR-MT from the network device.

In some embodiments, it is expected that the at least one of carrier(s) of the NCR-MT may operate in the frequency band forwarded by the NCR-Fwd, or the NCR-MT and NCR-Fwd operate in the same frequency band.

Further, as discussed above, the power consumption is always a focus in current wireless communication system. In order to reduce power consumption, it is proposed that the device may be configured in some power saving modes/states (such as, inactive state). In case of the inactive state, normal data transmissions and part of the signalling transmissions are proposed to be suspended.

Recently, it is proposed that the NCR may be transitioned into the inactive state. However, in case of the inactive state, if the NCR fails to determine/update the SCI information, the communication between the network device and the terminal device would be disturbed.

Some embodiments of the present disclosure provide a scheme for updating the SCI for a repeater device in an inactive state. With the scheme, a network device may generate and transmit a message for updating SCI to be used by the repeater device in the inactive state. With the updated SCI, the repeater may perform the communication with at least one of the network device or a terminal device properly.

Principles and implementations of the present disclosure will be described in detail below with reference to the figures.

### Example of Communication Network

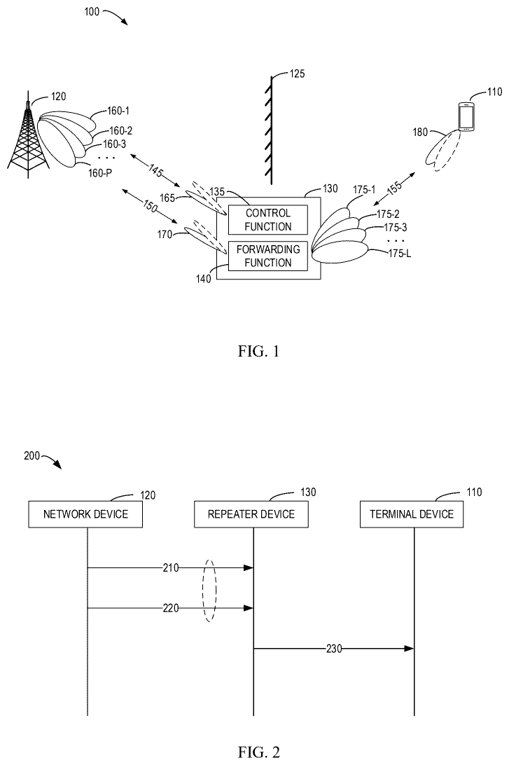

FIG. 1 illustrates a schematic diagram of an example communication network 100 in which some embodiments of the present disclosure can be implemented.

As shown in FIG. 1, the communication network 100 may comprise a terminal device 110 and a network device 120 that may serve the terminal device 110. Between the terminal device 110 and the network device 120, a block 125 may block out communications between the terminal device 110 and the network device 120 and thus cause a blocked or blind area out of coverage of the network device 120. The communication network 100 may further include a repeater device 130 to forward the communications between the terminal device 110 and the network device 120 in a blocked or blind area.

In some embodiments, the terminal device 110 and the network device 120 may communicate via the repeater device 130 with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

As shown in FIG. 1, the repeater device 130 may include a control function 135 and a forwarding function 140. The control function 135 may communicate with the network device 120 via a C-link 145. The forwarding function 140 may perform amplify-and-forwarding of UL/DL RF signals between the network device 120 and the terminal device 110 via a backhaul link 150 and an access link 155.

It should be understood that the control function 135 and the forwarding function 140 may have any suitable relative positions which may depend on network deployment or plan and/or hardware settings of the two modules 135 and 140 such as the number of antenna panels and/or the number of antennas. The control function 135 is shown to be collocated with or very close to the forwarding function 140 in FIG. 1 only for the purposes of illustration without suggesting any limitation. In some embodiments, the control function 135 may be separate from or even far way from the forwarding function 140 and cooperate with a plurality of forwarding functions if a plurality of blocks is present and interrupt transmission of RF signals between the network device 120 and the terminal device 110 in the communication network 100.

Further, beamforming may be used for communications in the communication network 100 to achieve better spatial directivity. As shown in FIG. 1, the network device 120 may use beams 160-1, 160-2, 160-3 . . . 160-P (individually or collectively referred to as a beam 160, P may represent any suitable integer) to communicate with the repeater device 130. The repeater device 130 may use a control beam 165 to communicate with the network device 120 via the control link 145 and use a backhaul beam 170 to communicate with the network device 120 via the backhaul link 150. The repeater device 130 may further use access beams 175-1, 175-2, 175-3 . . . 175-L (individually or collectively referred to as an access beam 175, L may represent any suitable integer) to communicate via the access link 155 with the terminal device 110 that may use a beam 180.

It should be understood that the numbers of beams configured for the terminal device 110, the network device 120 and the repeater device 130 are shown in FIG. 1 only for the purposes of illustration without suggesting any limitation. Depending on the network plan and the capabilities of the devices 110, 120 and 130 in the communication network 100, the device 110, 120 or 130 may be provided with any suitable number of beams.

In some embodiments, the SCI may comprise the following information for an NCR: beamforming information, timing information to align transmission/reception boundaries of an NCR, information on UL-DL TDD configuration, ON-OFF information for efficient interference management and improved energy efficiency, power control information for efficient interference management, and/or the like.

Some example processes for determining the backhaul resource will be discussed below, where the NCR is described as the example of the repeater device 130, NCR-MT is described as the example of the control function 135 and the NCR-Fwd is described as the example of the forwarding function 140.

In some embodiments, as for the backhaul link and C-link, both fixed beam and adaptive beam can be considered at the repeater device 130, where the fixed beam may refer to the case that beam at the NCR for both C-link and backhaul-link cannot be changed. Further, beam correspondence is assumed to apply for DL/UL of the backhaul link at the forwarding module, as well as the DL/UL of the C-link at NCR-MT.

In some embodiments, the same TCI states as C-link are assumed for the backhaul beam(s) at NCR-Fwd for backhaul link if the carrier(s) of the NCR-MT is operating within the frequency band forwarded by the NCR-Fwd.

In some embodiments, in case that the adaptive beams are adopted for C-link and backhaul link, the beam of backhaul link may be indicated by a newly-defined signaling. The newly-defined signaling may be a dynamic signaling and/or semi-static signaling (e.g., RRC signaling/MAC CE) indicating a beam(s) from the set of beams of the C-link. In other words, the beam of backhaul link is the same with the beam of C-link or is a subset of beams of the C-link.

In some embodiments, in case that the adaptive beams are adopted for C-link and backhaul link, the beam of backhaul link may be determined by a pre-defined rule. As one specific example, in slots/symbols with simultaneous DL receptions/UL transmissions in both C-link and backhaul link, the beam of backhaul link is the same as the beam of C-link. Otherwise, the beam of backhaul link follows one of the beams of the C-link.

In some embodiments, if the beam indication framework in release 15 is used for NCR-MT, the semi-static beam indication for backhaul link is supported. Specifically, the DL beam is indicated by MAC CE to select one of TCI state ID from the RRC-configured list of beams for C-link, while the UL beam is indicated by SRI on C-link via MAC CE.

In some embodiments, if the beam indication framework in release 17 is used for NCR-MT, the semi-static beam indication for backhaul link is supported. Specifically, the DL and UL beam are indicated by MAC CE to select one of TCI state ID from the RRC-configured list of beams for C-link.

In some embodiments, in the time domain resource with simultaneous downlink reception or uplink transmission in C-link and backhaul link, the beam of backhaul link is the same as the beam of C-link regardless of whether there is beam indicated by the dedicated signal for backhaul link.

Alternatively, in some embodiments, in the time domain resource without simultaneous downlink reception or uplink transmission in C-link and backhaul link, if the NCR does not support capability with the newly-defined signalling for backhaul beam indication or if no beam is indicated for backhaul link by the dedicated signal, the backhaul beam may be determined as below:
When release 15/16 beam indication framework is used for C-link, the beam determined by Quasi Co-Location (QCL) assumption for CORESET with the lowest identity (ID) and spatial relationship for PUCCH with lowest PUCCH resource ID in the C-link is applied for the DL and UL of backhaul link, respectively.
When release 17 beam indication framework (i.e., unified TCI framework) is used for C-link, the indicated unified TCI for C-link DL and UL is applied for the DL and UL of backhaul link, respectively.
Otherwise, the beam indicated by the dedicated signalling is applied for backhaul link.

The ON-OFF information is beneficial and recommended for NCR to control the behavior of NCR-Fwd. In some embodiments, the NCR-Fwd is always expected to be “OFF” unless otherwise explicitly or implicitly indicated by the network device 120 regardless of the RRC state of the NCR-MT.

In some embodiments, when the NCR-MT is in RRC-idle/inactive an indication (e.g., received when NCR-MT in RRC-connected) or a discontinuous reception (DRX) state of NCR-MT may be used for controlling the ON-OFF behavior of NCR-Fwd.

In some embodiments, the following options may be considered to indicate the ON-OFF information from gNB to NCR for controlling the behavior of NCR-Fwd, i.e., Option 1: explicit indication with ON-OFF state (e.g., via dynamic or semi-static signalling) or ON-OFF pattern (e.g., periodic/semi-static ON-OFF pattern or new DRX-like pattern for ON-OFF); Option 2: implicit indication via the signalling for other side-control information (e.g., beam, DL/UL configuration, or-power control (PC) information).

In some embodiments, as for frequency range (FR) 2, the “ON” state of NCR-Fwd is indicated by an implicit indication via the beam indication (i.e., if there is beam indication, the NCR is assumed to be ON over the indicated time domain resource associated with corresponding beam(s)). In some embodiments, as for FR1, the “ON” state of NCR-Fwd is indicated by indication via the beam indication (i.e., if there is beam indication, the NCR is assumed to be ON over the indicated time domain resource associated with corresponding beam(s)). Specifically, when there is only one beam, the purpose of the beam indication is for indicating “ON” state of NCR-Fwd. That is, the “ON” state of NCR-Fwd may be implicitly indicates via a beam indication, and further the related time domain resource has a strong correlation with the beam indication.

In some embodiments, when the NCR-MT is in the RRC_CONNECTED state, the NCR-Fwd may be ON or OFF following the side control information received from the gNB, and after the NCR-MT enters into the RRC_INACTIVE state, the NCR-Fwd may be ON or OFF following the last configuration received from the gNB.

In some embodiments, the NCR-MR may function similarly to a terminal device and a radio resource management may be supported by the NCR-MR. In this event, the cell selection is mandatory, where the cell reselection may be triggered in response to an RLM, BFD or BFR. In some embodiments, after the RLF is declared by NCR-MT, the NCR-MT may perform the cell selection and trigger RRC re-establishment. If the NCR-MT enters into the RRC_IDLE state due to failing to find a suitable cell, the NCR-Fwd is determined to be OFF. Further, during the RRC re-establishment procedure, the NCR-Fwd is determined to be OFF.

Below table 1 illustrates an example of ON-OFF information for respective phase of the NCR-MT.

TABLE 1
an example of ON-OFF information for
respective phase of the NCR-MT

| | ON-OFF information of |
|---|---|
| respective phase of the NCR-MT | the NCR-Fwd |
| Power on/RRC_IDLE | OFF |
| Enter into RRC Connected state | OFF |
| Receive configuration for receiving SCI, | OFF |
| via such as RRC signalling | |
| Receive SCI#1 indicating ON | ON |
| Receive SCI#2 for ON/OFF | ON/OFF |
| Enter intoRRC_INACTIVE as indicated | may be ON or OFF following |
| by the network device 120 (gNB) | the last configuration |
| | received from the gNB |
| RLF and re-establishment (suitable cell) | OFF |
| Enter into IDLE state due to radio | OFF |
| link failure (no suitable cell) | |

In some embodiments, the necessary configuration for receiving the Layer1/Layer2 (L1/L2) signaling of the SCI includes the following two aspects: the configurations of physical channels to carry the LT/L2 signaling, and the configurations of L1/L2 signaling.

In some embodiments, a periodic beam indication for access link may be indicated. As one example, one RRC signalling may be used with the information defined by a list of resources, where each forwarding resource may be represented as X and may be defined as a pair of {Beam index, time resource}, and the number of resources is larger or equal to 1 while smaller or equal to X_max.

In some embodiments, each time resource may be defined by {starting slot defined as the slot offset in one period, starting symbol defined by symbol offset within the slot, duration defined by the number of symbols} with dedicated field.

In some embodiments, the periodicity is configured as part of the RRC signaling for periodic beam indication and the same periodicity is assumed for all time resource(s) in one periodic beam indication. Additionally, in some embodiments, the reference SCS is configured as part of the RRC signaling for periodic beam indication and the same reference SCS is assumed for all time resource(s) in one periodic beam indication.

In some embodiments, the forwarding resource(s) for the access link is aperiodic, and a DCI message may be used for indicating the forwarding resource(s). The DCI message comprises:
L_max fields used to indicate the beam information and each field refers to one beam index; the bitwidth of this field is determined by the number of beams used for access link.
T_max fields used to indicate the time resource; a list of time resource is pre-defined by RRC signalling; the bitwidth of this field for time resource indication is determined by the length of list; the value of T_max may be either 1 or L_max.

In some embodiments, each time resource is defined by {starting slot defined as the slot offset, starting symbol defined by symbol offset within the slot, duration defined by the number of symbols} with dedicated field.

In some embodiments, in multi-beam operations, the terminal device 110/repeater device 130 (the NCR-MT) assumes that the same paging message and the same Short Message are repeated in all transmitted beams and thus the selection of the beam(s) for the reception of the paging message and Short Message is up to the implementation of the terminal device 110/repeater device 130 (the NCR-MT). The paging message is same for both radio access network (RAN) initiated paging and core network (CN) initiated paging.

In some embodiments, in multi-beam operations, the terminal device 110/repeater device 130 (the NCR-MT) assumes that the same paging early indication (PEI) is repeated in all transmitted beams and thus the selection of the beam(s) for the reception of the PEI is up to the implementation of the terminal device 110/repeater device 130 (the NCR-MT).

It is to be understood that the numbers the terminal device 110, the network device 120, the repeater device 130 and the managements device 125 are shown in FIG. 1 only for the purposes of illustration without suggesting any limitation. Depending on the network plan and the capabilities of the devices 110, 120, 125 and 130 in the communication network 100, the devices 110, 120, 125 or 130 may be provided with any suitable number of beams.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

### Example Processes

### Example Processes for Updating SCI for a Repeater Device in an Inactive State

Principle and implementations of the present disclosure will be described in detail below with reference to FIG. 2, which shows a signaling chart illustrating process 200 of communication according to some example embodiments of the present disclosure. For the purpose of discussion, the process 200 will be described with reference to FIG. 1. As illustrated in FIG. 2, the process 200 may involve the terminal device 110, the network device 120 and the repeater device 130. In the following descriptions, an NCR may be described as an example of the repeater device 130.

It is to be understood that SCI information may be indicated in any suitable manner. As one specific example, the SCI information comprises detailed information, including but not limited to, beamforming information, timing information to align transmission/reception boundaries of an NCR, information on UL-DL TDD configuration, ON-OFF information, power control information, and/or the like. In this way, the flexibility for updating the SCI is increased.

Alternatively, the SCI may be pre-configured (for example, via RRC signalling or system information) or pre-defined (such as, by the wireless standards, the network operator or the service provider) as more than one parameter set. Further, each parameter set may be identified by an SCI set index. In this event, the SCI may be indicated via a respective SCI set index. In this way, the overhead for indicating the SCI is reduced.

In operation, the network device 120 generates and transmits 210 an RRC release message for transitioning the repeater device 130 (MT NCR) into the inactive state. Next, the network device 120 generates and transmits 220 a message for updating the SCI to be used by the repeater device 130 in the inactive state.

As discussed above, the updated SCI may either be detailed information or an SCI set index. Merely for brevity, the following text would not emphasize this repeatedly.

Further, as indicated in FIG. 2, the updated SCI may be comprised in the RRC release message, for example, as a dedicated information element (IE) or comprised in the IE of suspendConfig. The present disclosure is not limited in this regard.

Then, by using the updated SCI, the repeater device 130 may perform 230 a communication with at least one of the network device 120 or the terminal device 110.

According to the present disclosure, the message for updating the SCI may be a newly-defined signalling, or an existing signalling reused for updating the SCI. The present disclosure is not limited in this regard.

In some embodiments, the message for updating the SCI may be an RRC release message as discussed above. In this event, the network device 120 may transition the repeater device 130 into the inactive device and indicate the SCI to the used by the repeater device 130 in the inactive state with a single signalling.

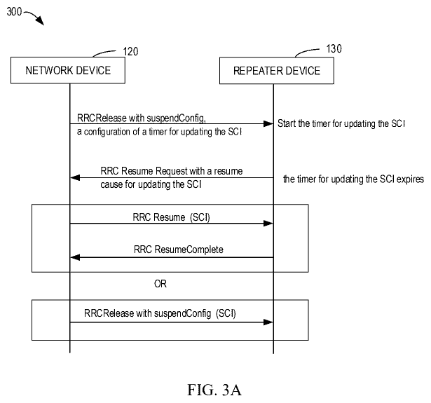

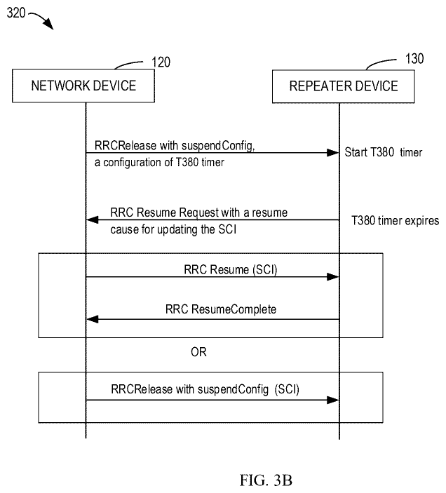

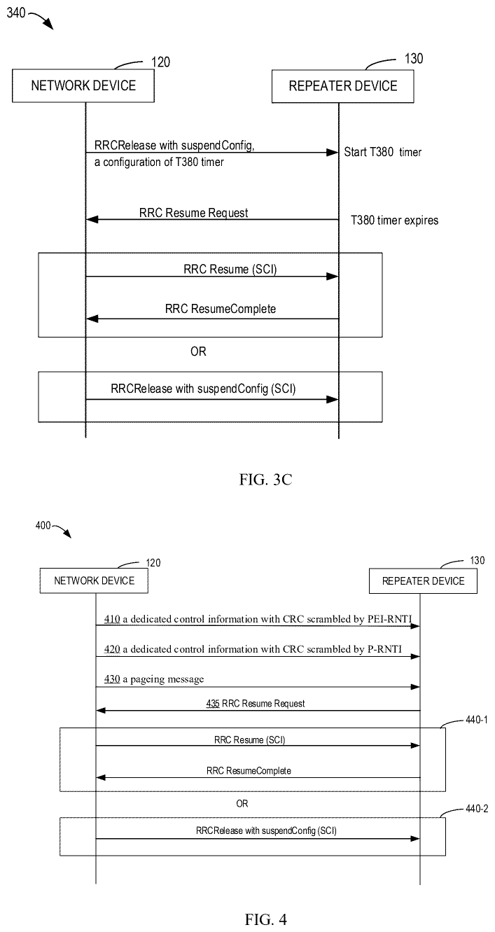

Alternatively, or in addition, in some embodiments, the message for updating the SCI may be an RRC resume message (as indicated in FIGS. 3A to 4), that is because when the repeater device 130 is in the inactive state, the repeater device 130 may transmit an RRC resume request to initiate an RRC resume procedure and the network device 120 may transmit an RRC resume message in response to receiving an RRC resume request from the repeater device 130.

Alternatively, or in addition, in some embodiments, the message for updating the SCI may be a mobile terminated (MT) small data transmission (SDT). In this way, the SCI for the repeater device 130 may be updated without the repeater device 130 transitioning into a connected state.

Alternatively, or in addition, in some embodiments, the message for updating the SCI may be a dedicated control information with CRC scrambled by paging early indication (PEI) RNTI (PEI-RNTI), a dedicated control information with cyclic redundancy check (CRC) scrambled by paging radio network temporary identity (P-RNTI) or a paging message.

Additionally, in order to reduce signalling overhead, the SCI may be indicated by using the SCI set index as discussed above. After receiving any of the above three messages, the repeater device 130 may obtain the updated SCI according to the indicated SCI set index directly. In this event, the procedure for updating the SCI may is complete. As a result, the repeater device 130 does not need to initiate the following RRC resume procedure (e.g., send an RRC resume request).

In this way, other device rather than the repeater device 130 may ignore the above message, and only the repeater device 130 needs to monitor/detect the following signalling.

In some embodiments, the repeater device 130 may request the network device 120 to update the SCI. In one specific example embodiment, prior to receiving the message for updating the SCI from the network device 120, the repeater device 130 may transmit an RRC resume request message to the network device 120 in response to an expiry of a timer for updating the SCI, where the RRC resume request message is used for requesting the network device 120 to update the SCI.

Additionally, in some embodiments, the RRC release message comprises a configuration of the timer. For example, the RRC release message indicates the periodicity value for the timer, where the periodicity value may be comprised in the dedicated information element (IE) or in the IE of suspendConfig. The present disclosure is not limited in this regard.

In some embodiments, the timer for updating the SCI is a dedicated/specific timer configured for updating the SCI, as shown in FIG. 3A. In some embodiments, a granularity unit of the timer is one of second or millisecond. In this way, the SCI may be updated timely for the repeater device 130 in the inactive state.

Alternatively, in some embodiments, the timer for updating the SCI is a timer for updating a radio access network (RAN) notification area (RNA) (i.e., T380 timer) which is reused for updating the SCI, as shown in FIGS. 3B and 3C. In this event, as the periodicity for updating SCI is shorter than a regular T380, in some embodiments, the periodicity for T380 may be re-configured.

In some embodiments, the RRC resume request message transmitted by the repeater device 130 may comprise a resume cause for updating the SCI, as shown in FIGS. 3A and 3B. In this way, the network device 120 may better distinguish the regular RRC resume request and the RRC resume request for updating the SCI.

In some embodiments, prior to transmitting the message for updating the SCI, the network device 120 may transmit an indicating to the repeater device 130 to instruct the repeater device 130 to receive the message for updating the SCI. Example processes for this feature will be discussed with reference to FIG. 4.

It is to be clarified that, in the specific example of FIG. 4, three messages may be utilized, i.e., a dedicated control information with CRC scrambled by PEI-RNTI, a dedicated control information with CRC scrambled by P-RNTI or a paging message.

In summary, the above three message may comprise an SCI set index. In this way, the above three message may be used for updating the SCI. Moreover, the above three message may comprise respective indication which indicates the repeater device 130 to receive the message for updating the SCI. Regardless of how to utilize the above three messages, it may be understood that only the repeater device 130 needs to perform additional operation(s) for receiving the message for updating the SCI.

In some embodiments, the network device 120 may transmit 410 a first indication for indicating the repeater device 130 to receive the message for updating the SCI during a paging early indication (PEI) occasion, where the first indication is comprised in a dedicated control information with CRC scrambled by PEI-RNTI. In this event, only the repeater device needing to update the SCI is instructed to communicate with network device 120 for receiving the message (i.e., action 435, and block 440-1/440-2). The repeater device 130 detects the first indication/dedicated control information with CRC scrambled by PEI-RNTI on the PDCCH.

In some embodiments, the first indication is comprised in afield of PEI in the dedicated control information with CRC scrambled by PEI-RNTI.

Alternatively, in some embodiments, the network device 120 may transmit 420 a second indication for indicating the repeater device 130 to receive the message for updating the SCI during a paging occasion, where second indication is comprised in dedicated control information with CRC scrambled by P-RNTI. In this event, only the repeater device needing to update the SCI is instructed to communicate with network device 120 for receiving the message (i.e., action 435, and block 440-1/440-2). The repeater device 130 detects the second indication/dedicated control information with CRC scrambled by P-RNTI on the PDCCH.

In some embodiments, the second indication is comprised in a field of short message in the dedicated control information with CRC scrambled by P-RNTI.

In some embodiments, the first or the second indication may be a 1-bit indication.

In some embodiments, the repeater device 130 detects the PDCCH in its paging occasion and if the repeater device 130 detects the SCI updating indication (i.e., the first or the second indication), the repeater device 130 will receive PDSCH/paging information/PagingRecord scheduled by the PDCCH and initiate an RRC resume procedure. Additionally, when initiating the RRC resume procedure, the repeater device 130 may transmit a RRC resume request to the network device 120 (where the RRC Resume Request may comprise a resume cause indicating to update the SCI, such as, resume cause is set to be sci-Update as illustrated in FIG. 3A and FIG. 3B).

Alternatively, in some embodiments, the network device 120 may transmit 430 a third indication for indicating the repeater device 130 to receive the message for updating the SCI on a physical downlink shared channel (PDSCH), where the third indication is comprised in a paging message. For example, the third indication may be a 1-bit indication. In this event, other device rather than the repeater device 130 does not need to communicate with network device 120 for receiving the message (i.e., action 435, and block 440-1/440-2).

In some embodiments, if the ue-Identity included in the PagingRecord matches the stored fullI-RNTI of the repeater device 130 and if the third indication is present in the paging message, the repeater device 130 will initiate an RRC resume procedure to receiving the message for updating the SCI.

In some embodiments, the third indication may be 1-bit indication, a paging cause indicating to receive the message for updating the SCI, the ID of the repeater device 130.

In this event, if the paging message includes the ID of the repeater device 130 (or the1-bit indication, or a paging cause indicating to receive the message), the repeater device 130 may initiate an RRC resume procedure (e.g., send an RRC resume request) as described above to update the SCI.

In some embodiments, the third indication is comprised in a field for indicating a paging cause.

Alternatively, in some embodiments, if the paging cause indicates SCI updating, the repeater device 130 will initiate an RRC resume procedure to receive the message for updating the SCI.

With the above example processes, the SCI to be used by the repeater device in the inactive state may be updated timely.

For better understanding, some example processes will be further discussed.

In some embodiments, a specific/dedicated timer and/or a specific cause value may be defined for updating SCI.

Reference is now made to FIG. 3A, which illustrates a signaling chart illustrating process 300 of communication according to some example embodiments of the present disclosure.

In the specific example of FIG. 3A, the network device 120 configures the repeater device 130 (NCR-MT) with a specific timer for updating the SCI.

As illustrated in FIG. 3A, the specific timer for updating the SCI may be configured via an RRCRelease message which used for transitioning the repeater device 130 into the inactive state. In some embodiments, the configuration for the specific timer is comprised in RRCRelease message as a dedicated information element (IE). Alternatively, the configuration for the specific timer is comprised in the IE of suspendConfig of the RRCRelease message. The present disclosure is not limited in this regard.

As illustrated in FIG. 3A, the repeater device 130 starts the specific timer for updating the SCI after receiving the RRCRelease message. Then, when the specific timer for updating the SCI expires, the repeater device 130 initiates an RRC connection resume procedure with the network device 120. Specifically, the repeater device 130 transmits an RRC Resume Request to the network device 120, where the RRC Resume Request may comprise a resume cause indicating to update the SCI (such as, resume cause is set to be sci-Update).

In some embodiments, the network device 120 updates the SCI in the RRC Release message. Alternatively, as illustrated in FIG. 3A, the network device 120 updates the SCI in the RRCResume message/RRC Release with suspendConfig. Alternatively, the network device 120 updates the SCI during an MT-SDT.

Further, the repeater device 130 also may be configured with T380 timer. In this event, if the specific timer for updating the SCI and T380 timer expire at the same time, the repeater device 130 may initiate RRC connection resume procedure for updating the SCI.

In some embodiments, the granularity unit of the specific timer for updating the SCI may be one of millisecond, second, minute, hour, or slot(s). For example, the periodicity of the specific timer may be configured to be 5 s, 10 s, 20 s, 30 s, 60 s, 5 minutes, 10 minutes, 20 minutes, 30 minutes, 60 minutes, 120 minutes, 360 minutes, 720 minutes and so on.

Alternatively, in some embodiments, an existing timer may be reused for updating the SCI.

Reference is now made to FIG. 3B, which illustrates a signaling chart illustrating process 320 of communication according to some example embodiments of the present disclosure.

In the specific example of FIG. 3B, T380 timer is reused for indicating the SCI. As illustrated in FIG. 3B, T380 may be configured via the RRCRelease message which used for transitioning the repeater device into the inactive state.

In some embodiments, the configuration for T380 timer is comprised in RRCRelease message as a dedicated information element (IE). Alternatively, the configuration for T380 timer is comprised in the IE of suspendConfig of the RRCRelease message. The present disclosure is not limited in this regard.

As illustrated in FIG. 3B, the repeater device 130 starts T380 timer after receiving the RRCRelease message. Then, when T380 timer expires, the repeater device 130 initiates the RRC connection resume procedure with the network device 120. Specifically, the repeater device 130 transmits an RRC Resume Request to the network device 120, where the RRC Resume Request may comprise a resume cause indicating to update the SCI (such as, resume cause is set to be sci-Update). This solution is practical because the feature may be implemented as an optional capability of the repeater device 130, and the network device 120 does not need to distinguish the NCR from regular terminal devices.

In some embodiments, the network device 120 updates the SCI in the RRC Release message. Alternatively, the network device 120 updates the SCI in the RRCResume message/RRC Release with suspendConfig. Alternatively, the network device 120 updates the SCI after the repeater device 130 transitioning into the RRC connected state.

Further refer to FIG. 3C, which illustrates a signaling chart illustrating process 340 of communication according to some example embodiments of the present disclosure.

In the specific example of FIG. 3C, T380 timer is reused for updating SCI. Different from the example of FIG. 3B, upon the expiry of T380 timer, the repeater device 130 transmits an RRC Resume Request to the network device 120 without comprising the SCI updating indication. By contrast, the RRC Resume Request comprises a resume cause for updating RNA (esumeCause set to ma-Update). However, the network device 120 may understand that the RRC Resume Request is transmitted from the repeater device 130. Thus, the network device 120 may provide the updated SCI for the repeater device 130 in the following signalling.

Similar with example of FIG. 3B, in some embodiments, the network device 120 may update the SCI in the RRC Release message. Alternatively, the network device 120 may update the SCI in the RRCResume message/RRC Release with suspendConfig. Alternatively, the network device 120 may update the SCI after the repeater device 130 transitioning into the RRC connected state.

Further, in some embodiments, the granularity unit of T380 timer may be one of millisecond, second, minute, hour, or slot(s). For example, the periodicity of T380 timer may be configured to be 5 s, 10 s, 20 s, 30 s, 60 s, 5 minutes, 10 minutes, 20 minutes, 30 minutes, 60 minutes, 120 minutes, 360 minutes, 720 minutes and so on.

Alternatively, in some embodiments, the SCI may be updated by utilizing the RAN paging procedure.

Reference is now made to FIG. 4, which illustrates a signaling chart illustrating process 400 of communication according to some example embodiments of the present disclosure.

It is to be clarified that, three messages may be utilized, i.e., a dedicated control information with CRC scrambled by PEI-RNTI, a dedicated control information with CRC scrambled by P-RNTI or a paging message.

As discussed above, the above three message may comprise an SCI set index, in this way, the above three message may be used for updating the SCI. Alternatively, the above three message may comprise respective indication which indicates the repeater device 130 to receive the message for updating the SCI. Regardless of how to utilize the above three messages, it may be understood that only the repeater device 130 needs to perform additional operation for receiving the message for updating the SCI.

### Example Processes for BFR

In some embodiments, the repeater device 130 detects a beam failure on a control link between the repeater device 130 and a network device 120, and during a beam failure recovery (BFR), the repeater device 130 determines a forwarding function of the repeater device 130 to be OFF. In this way, unnecessary power consumption is saved.

In some embodiments, after a beam failure (BF) is detected/declared by the repeater device 130 (NCR-MT), the repeater device 130 (NCR-MT) may initiate to perform a BFR procedure.

In some embodiments, configuring the forwarding function of the repeater device 130 to be OFF is conditionally performed. In one specific example embodiment, the repeater device 130 configures the forwarding function of the repeater device 130 to be OFF comprises only if at least one of the following:
a beam for a backhaul link between the repeater device 130 and the network device 120 is the same with a beam of the control link;
a transmission configuration indication (TCI) state set for the backhaul link is a subset of a TCI state set for the control link; or
the backhaul link and the control link are operated in a same frequency resource.

In one specific embodiment, the repeater device 130 configures the forwarding function of the repeater device 130 to be OFF if the backhaul link and the C-link are operated in-band. If the repeater device 130 is an NCR, the meaning of “in-band” may refer to that the carrier(s) of the NCR-MT is operating within the frequency band forwarded by the NCR-Fwd. In other words, the NCR-MT and the backhaul of NCR-Fwd share the same frequency bands/carriers, or the NCR-MT and the backhaul of NCR-Fwd operate on the same carrier.

In another specific embodiment, the repeater device 130 configures the forwarding function of the repeater device 130 to be OFF if the TCI states of backhaul link reuse at least one TCI state of the C-link. That is, the TCI states of backhaul link are the same as those of C-link, or the TCI states of backhaul link is a subset of those of C-link.

In this way, the configuration for the forwarding function is configured to be OFF properly.

In some embodiments, after the BFR is successfully completed, the repeater device 130 determines the forwarding function of the repeater device 130 to be ON or OFF according to previously received side control information (SCI) from the network device 120. In this way, the communications may be recovered timely.

### Example Processes for Resource Configuration

In some cases, the repeater device 130 may be configured with periodic or aperiodic resource before transitioning into the inactive state. After transitioning into the inactive state, there may be some residual resources. Thus, how to handle such residual resources needs to be further discussed.

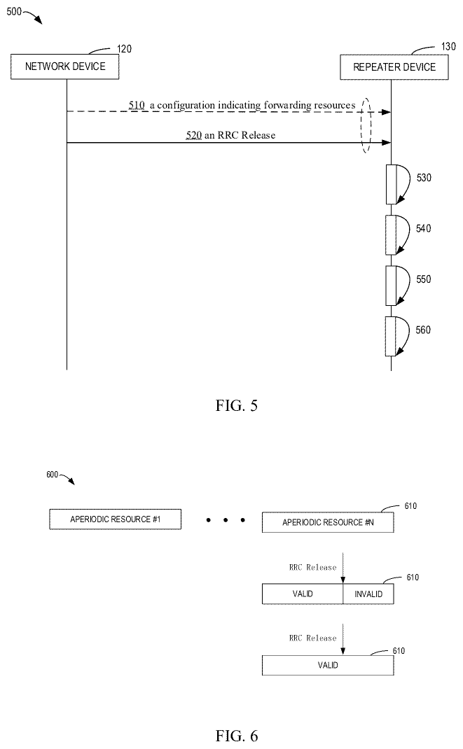

Principle and implementations of the present disclosure will be described in detail below with reference to FIG. 5, which shows a signaling chart illustrating process 500 of communication according to some example embodiments of the present disclosure. For the purpose of discussion, the process 500 will be described with reference to FIG. 1. As illustrated in FIG. 5, the process 500 may involve the network device 120 and the repeater device 130. In the following descriptions, an NCR may be described as an example of the repeater device 130.

In operation, the repeater device 130 receives 510 a configuration indicating resources to be used for a communication between the repeater device 130 and a terminal device, from a network device 120. Next, the repeater device 130 receives 520 an RRC release message for transitioning the repeater device 130 into an inactive state from the network device 120.

Further, as indicated in FIG. 5, the configuration indicating the resources may be comprised in the RRC release message, for example, as a dedicated information element (IE) or comprised in the IE of suspendConfig. The present disclosure is not limited in this regard.

In some embodiments, after transitioning into the inactive state, the repeater device 130 maintains 530 availability of the resources in case that the resources are periodic resources.

Alternatively, in some embodiments, after transitioning into the inactive state, in case that the resources are aperiodic resources, the repeater device 130 maintains 540 the availability of the resources or invalids the resources, as shown in FIG. 6.

In summary, in some embodiments, only the configuration indicated by the periodic beam indication may be reused/reserved. In this event, the repeater device 130 may stop the forwarding on resources indicated by the aperiodic beam indication.

Alternatively, in some embodiments, both two periodic and aperiodic resources may be reused/reserved. Additionally, the aperiodic beam indication is still available till the end the time domain resource indicated by it.

In this way, the using of out-of-date configuration is avoided and the interference caused by using of out-of-date configuration is avoided accordingly.

### Example Processes for Determining Backhaul Beam

Still refer to FIG. 5. In some embodiments, the repeater device 130 receive 520, an RRC release message for transitioning the repeater device 130 into an inactive state from a network device 120. Then, the repeater device 130 determines 550 a backhaul beam for a backhaul link between the repeater device 130 and the network device 120 based on a control beam for a control link between the repeater device 130 and the network device 120.

In some embodiments, the control beam is indicated by the RRC release or determined by the repeater device 130.

In one specific embodiment, the repeater device 130 reserves the configuration of beams receive before entering RRC_INACTIVE state. Additionally, only the repeater device 130 capable of semi-static beam indication may reserve the configuration. Additionally, only one TCI state is reserved, such as the TCI state with the lowest ID in the RRC-configured list of beams for C-link.

In another specific embodiment, the repeater device 130 may use the beam(s) indicated in the RRCRelease message (with suspend configuration) for C-link, and then the beam of backhaul link is the same as the beam of C-link. alternatively, or in addition, the pre-defined rules as discussed previously in the present discourse may be applied to determine the beam for backhaul link. The beam(s) for C-link may be indicated by a list of TCI-state ID.

In another specific embodiment, the selection of beams of C-link is up to the implementation of the repeater device 130, and the beam of backhaul link is the same as the beam of C-link. No matter that the time domain resource with/without simultaneous downlink reception or uplink transmission in C-link and backhaul link. Further, the repeater device 130 may assume that the same data to be forwarded by NCR are repeated in all transmitted beams, such as, SSB, cell common information, UE dedicated data and so on.

Additionally, other SCI for backhaul link of the repeater device 130 may be indicated explicitly in RRCRelease message. Alternatively, Other SCI configured before RRCRelease message can be reused.

The above discussion is especially suitable for the downlink transmission on the backhaul link, that is because the downlink transmission is repeatedly transmitted on all the beams by the network device 120. As for the uplink transmission, similar operations may be supported by the repeater device 130. Specifically, when forwarding the uplink transmission to the network device 120, the repeater device 130 may repeatedly transmit the uplink transmission on all the beams. Optionally, the repeater device 130 may stop the repeatedly transmitting if the repeater device 130 receives any positive feedback from the network device 120.

Alternatively, or in addition, in some embodiments, the repeater device 130 may determine 560 a forwarding function of the repeater device 130 to be ON or OFF according to previously received side control information (SCI) from the network device 120 in case that the backhaul beam is available.

In one specific embodiments, After NCR-MT enters RRC_INACTIVE mode, the NCR-Fwd can be ON or OFF following the last configuration of access link. Further, the NCR-Fwd can be ON only if the beam for NCR-MT in RRC_INACTIVE is indicated explicitly, or only if the beam for NCR-MT in RRC_INACTIVE is available (e.g., SSB beam), or only if the SCI for the backhaul link is available.

In this way, the backhaul resource to be used by the repeater device 130 may be determined properly.

### Example Methods

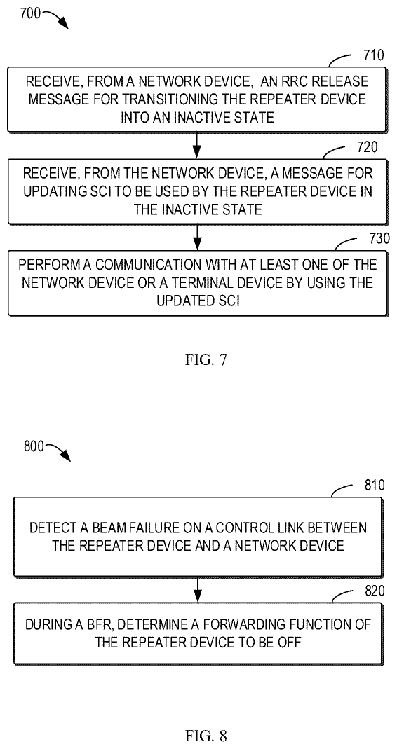

FIG. 7 illustrates a flowchart of a communication method 700 implemented at a repeater device in accordance with some embodiments of the present disclosure. For the purpose of discussion, the method 700 will be described from the perspective of the repeater device 130 in FIG. 1.

At block 710, the repeater device receives, from a network device, a radio resource control (RRC) release message for transitioning the repeater device into an inactive state.

At block 720, the repeater device receives, from the network device, a message for updating side control information (SCI) to be used by the repeater device in the inactive state.

At block 730, the repeater device performs a communication with at least one of the network device or a terminal device by using the updated SCI.

In some example embodiments, the message for updating the SCI is one of the following: the RRC release message, an RRC resume message, a mobile terminated (MT) small data transmission (SDT), a paging message, a dedicated control information with cyclic redundancy check (CRC) scrambled by paging radio network temporary identity (P-RNTI), a dedicated control information with CRC scrambled by paging early indication (PEI) RNTI (PEI-RNTI).

In some example embodiments, the method further comprises: prior to receiving the message for updating the SCI from the network device, in response to an expiry of a timer for updating the SCI, transmitting, to the network device, an RRC resume request message for requesting to update the SCI.

In some example embodiments, the RRC resume request message comprises a resume cause for updating the SCI.

In some example embodiments, the timer is a dedicated timer configured for updating the SCI, or the timer is a timer for updating a radio access network (RAN) notification area (RNA) which is reused for updating the SCI.

In some example embodiments, a granularity unit of the timer is one of second or millisecond.

In some example embodiments, the RRC release message comprises a configuration of the timer.

In some example embodiments, the method further comprises: prior to receiving the message for updating the SCI from the network device, detecting one of the following: a first indication for indicating the repeater device to receive the message for updating the SCI, the first indication being comprised in a dedicated control information with CRC scrambled by PEI-RNTI, during a paging occasion, a second indication for indicating the repeater device to receive the message for updating the SCI, the second indication being comprised in dedicated control information with cyclic redundancy check (CRC) scrambled by paging radio network temporary identity (P-RNTI), on a physical downlink shared channel (PDSCH), or a third indication for indicating the repeater device to receive the message for updating the SCI, the third indication being comprised in a paging message, or during a paging early indication (PEI) occasion.

In some example embodiments, the first indication is comprised in a field of PEI in the dedicated control information with CRC scrambled by PEI-RNTI.

In some example embodiments, the second indication is comprised in a field of short message in the dedicated control information with CRC scrambled by P-RNTI.

In some example embodiments, the third indication is comprised in a field for indicating a paging cause.

In some example embodiments, the SCI is associated with at least one of the following: an access link between the repeater device and the terminal device, or a backhaul link between the repeater device and the network device.

FIG. 8 illustrates a flowchart of a communication method 800 implemented at a repeater device in accordance with some embodiments of the present disclosure. For the purpose of discussion, the method 800 will be described from the perspective of the repeater device 130 in FIG. 1.

At block 810, the repeater device detects a beam failure on a control link between the repeater device and a network device.

At block 820, during a beam failure recovery (BFR), the repeater device determines a forwarding function of the repeater device to be OFF.

In some example embodiments, configuring the forwarding function of the repeater device to be OFF comprises: configuring the forwarding function of the repeater device to be OFF if at least one of the following: a beam for a backhaul link between the repeater device and the network device is the same with a beam of the control link; a transmission configuration indication (TCI) state set for the backhaul link is a subset of a TCI state set for the control link; or the backhaul link and the control link are operated in a same frequency resource.

In some example embodiments, the method further comprises: after the BFR is successfully completed, determining the forwarding function of the repeater device to be ON or OFF according to previously received side control information (SCI) from the network device.

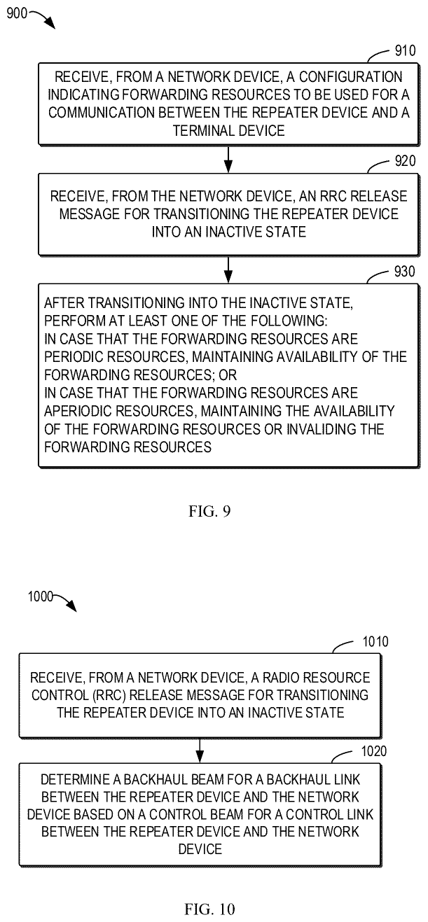

FIG. 9 illustrates a flowchart of a communication method 900 implemented at a repeater device in accordance with some embodiments of the present disclosure. For the purpose of discussion, the method 900 will be described from the perspective of the repeater device 130 in FIG. 1.

At block 910, the repeater device receives, from a network device, a configuration indicating resources to be used for a communication between the repeater device and a terminal device.

At block 920, the repeater device receives, from the network device, a radio resource control (RRC) release message for transitioning the repeater device into an inactive state.

At block 930, after transitioning into the inactive state, the repeater device performs at least one of the following: in case that the resources are periodic resources, maintaining availability of the resources; or in case that the resources are aperiodic resources, maintaining the availability of the resources or invaliding the resources.

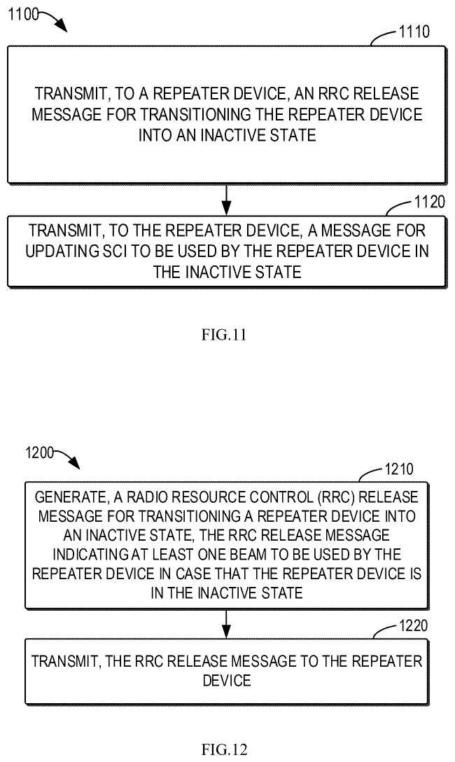

FIG. 10 illustrates a flowchart of a communication method1000 implemented at a repeater device in accordance with some embodiments of the present disclosure. For the purpose of discussion, the method1000 will be described from the perspective of the repeater device 130 in FIG. 1.

At block1010, the repeater device receives, from a network device, a radio resource control (RRC) release message for transitioning the repeater device into an inactive state.

At block1020, the repeater device determines a backhaul beam for a backhaul link between the repeater device and the network device based on a control beam for a control link between the repeater device and the network device, the control beam being indicated by the RRC release or determined by the repeater device.

In some example embodiments, the repeater device determines a forwarding function of the repeater device to be ON or OFF according to previously received side control information (SCI) from the network device in case that the backhaul beam is available.

FIG. 11 illustrates a flowchart of a communication method 1100 implemented at a network device in accordance with some embodiments of the present disclosure. For the purpose of discussion, the method 1100 will be described from the perspective of the network device 120 in FIG. 1.

At block 1110, the network device transmits, at a network device, to a repeater device, a radio resource control (RRC) release message for transitioning the repeater device into an inactive state.

At block 1120, the network device transmits, to the repeater device, a message for updating side control information (SCI) to be used by the repeater device in the inactive state.

In some example embodiments, the message for updating the SCI is one of the following: the RRC release message, an RRC resume message, a mobile terminated (MT) small data transmission (SDT), a paging message, a dedicated control information with cyclic redundancy check (CRC) scrambled by paging radio network temporary identity (P-RNTI), a dedicated control information with CRC scrambled by paging early indication (PEI) RNTI (PEI-RNTI).

In some example embodiments, the method further comprises: prior to transmitting the message for updating the SCI from the network device, receiving, from the repeater device, an RRC resume request message for requesting to update the SCI, the RRC resume request message being transmitted by the repeater device in response to an expiry of a timer for updating the SCI.

In some example embodiments, the RRC resume request message comprises a resume cause for updating the SCI.

In some example embodiments, the timer is a dedicated timer configured for updating the SCI, or the timer is a timer for updating a radio access network (RAN) notification area (RNA) which is reused for updating the SCI.

In some example embodiments, a granularity unit of the timer is one of second or millisecond.

In some example embodiments, the RRC release message comprises a configuration of the timer.

In some example embodiments, the method further comprises: prior to transmitting the message for updating the SCI from the network device, transmitting one of the following: during a paging early indication (PEI) occasion, a first indication for indicating the repeater device to receive the message for updating the SCI, the first indication being comprised in a dedicated control information with CRC scrambled by PEI-RNTI, during a paging occasion, a second indication for indicating the repeater device to receive the message for updating the SCI, the second indication being comprised in dedicated control information with cyclic redundancy check (CRC) scrambled by paging radio network temporary identity (P-RNTI), on a physical downlink shared channel (PDSCH), or a third indication for indicating the repeater device to receive the message for updating the SCI, the third indication being comprised in a paging message.

In some example embodiments, the first indication is comprised in a field of PEI in the dedicated control information with CRC scrambled by PEI-RNTI.

In some example embodiments, the second indication is comprised in a field of short message in the dedicated control information with CRC scrambled by P-RNTI.

In some example embodiments, the third indication is comprised in a field for indicating a paging cause.

In some example embodiments, the SCI is associated with at least one of the following: an access link between the repeater device and the terminal device, or a backhaul link between the repeater device and the network device.

FIG. 12 illustrates a flowchart of a communication method 1200 implemented at a network device in accordance with some embodiments of the present disclosure. For the purpose of discussion, the method 1200 will be described from the perspective of the network device 120 in FIG. 1.

At block 1210, the network device generates, at a network device, a radio resource control (RRC) release message for transitioning a repeater device into an inactive state, the RRC release message indicating at least one beam to be used by the repeater device in case that the repeater device is in the inactive state.

At block 1220, the network device transmits the RRC release message to the repeater device.

### Example Devices and Apparatus

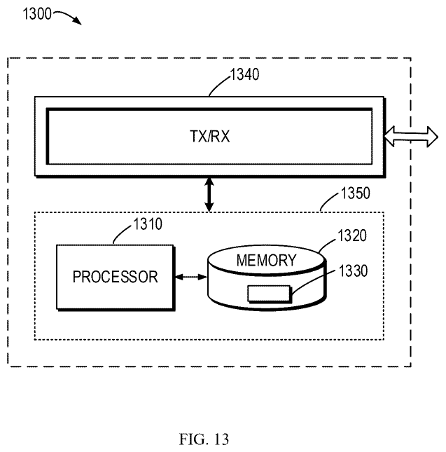

FIG. 13 is a simplified block diagram of a device 1300 that is suitable for implementing embodiments of the present disclosure. The device 1300 can be considered as a further example implementation of any of the devices as shown in FIG. 1. Accordingly, the device 1300 can be implemented at or as at least a part of the repeater device 130 or the network device 120.

As shown, the device 1300 includes a processor 1310, a memory 1320 coupled to the processor 1310, a suitable transmitter (TX)/receiver (RX) 1340 coupled to the processor 1310, and a communication interface coupled to the TX/RX 1340. The memory 1310 stores at least a part of a program 1330. The TX/RX 1340 is for bidirectional communications. The TX/RX 1340 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, Sl/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1330 is assumed to include program instructions that, when executed by the associated processor 1310, enable the device 1300 to operate in accordance with the embodiments of the present disclosure, as discussed herein with reference to FIGS. 1 to 12. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

In some embodiments, a repeater device comprises a circuitry configured to: receiving, at a repeater device and from a network device, a radio resource control (RRC) release message for transitioning the repeater device into an inactive state; receiving, from the network device, a message for updating side control information (SCI) to be used by the repeater device in the inactive state; and performing a communication with at least one of the network device or a terminal device by using the updated SCI. According to embodiments of the present disclosure, the circuitry may be configured to perform any of the method implemented by the repeater device as discussed above.

In some embodiments, a repeater device comprises a circuitry configured to: detecting, at a repeater device, a beam failure on a control link between the repeater device and a network device; and during a beam failure recovery (BFR), determining a forwarding function of the repeater device to be OFF. 14. The method of claim 13, wherein configuring the forwarding function of the repeater device to be OFF comprises: According to embodiments of the present disclosure, the circuitry may be configured to perform any of the method implemented by the repeater device as discussed above.

In some embodiments, a repeater device comprises a circuitry configured to: receiving, at a repeater device and from a network device, a configuration indicating resources to be used for a communication between the repeater device and a terminal device; receiving, from the network device, a radio resource control (RRC) release message for transitioning the repeater device into an inactive state; after transitioning into the inactive state, performing at least one of the following: in case that the resources are periodic resources, maintaining availability of the resources; or in case that the resources are aperiodic resources, maintaining the availability of the resources or invaliding the resources. According to embodiments of the present disclosure, the circuitry may be configured to perform any of the method implemented by the repeater device as discussed above.

In some embodiments, a repeater device comprises a circuitry configured to: receiving, at a repeater device and from a network device, a radio resource control (RRC) release message for transitioning the repeater device into an inactive state; and determining a backhaul beam for a backhaul link between the repeater device and the network device based on a control beam for a control link between the repeater device and the network device, the control beam being indicated by the RRC release or determined by the repeater device. According to embodiments of the present disclosure, the circuitry may be configured to perform any of the method implemented by the repeater device as discussed above.

In some embodiments, a network device comprises a circuitry configured to: transmitting, at a network device, to a repeater device, a radio resource control (RRC) release message for transitioning the repeater device into an inactive state; and transmitting, to the repeater device, a message for updating side control information (SCI) to be used by the repeater device in the inactive state. According to embodiments of the present disclosure, the circuitry may be configured to perform any of the method implemented by the network device as discussed above.

In some embodiments, a network device comprises a circuitry configured to: generating, at a network device, a radio resource control (RRC) release message for transitioning a repeater device into an inactive state, the RRC release message indicating at least one beam to be used by the repeater device in case that the repeater device is in the inactive state; and According to embodiments of the present disclosure, the circuitry may be configured to perform any of the method implemented by the network device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, a method of communication comprises: receiving, at a repeater device and from a network device, a radio resource control (RRC) release message for transitioning the repeater device into an inactive state; receiving, from the network device, a message for updating side control information (SCI) to be used by the repeater device in the inactive state; and performing a communication with at least one of the network device or s terminal device by using the updated SCI.

In some embodiments, the message for updating the SCI is one of the following: the RRC release message, an RRC resume message, a mobile terminated (MT) small data transmission (SDT), a paging message, a dedicated control information with cyclic redundancy check (CRC) scrambled by paging radio network temporary identity (P-RNTI), a dedicated control information with CRC scrambled by paging early indication (PEI) RNTI (PEI-RNTI).

In some embodiments, the method further comprises: prior to receiving the message for updating the SCI from the network device, in response to an expiry of a timer for updating the SCI, transmitting, to the network device, an RRC resume request message for requesting to update the SCI.

In some embodiments, the RRC resume request message comprises a resume cause for updating the SCI.

In some embodiments, the timer is a dedicated timer configured for updating the SCI, or the timer is a timer for updating a radio access network (RAN) notification area (RNA) which is reused for updating the SCI.

In some embodiments, a granularity unit of the timer is one of second or millisecond.

In some embodiments, the RRC release message comprises a configuration of the timer.

In some embodiments, the method further comprises: prior to receiving the message for updating the SCI from the network device, detecting one of the following: during a paging early indication (PEI) occasion, a first indication for indicating the repeater device to receive the message for updating the SCI, the first indication being comprised in a dedicated control information with CRC scrambled by PEI-RNTI, during a paging occasion, a second indication for indicating the repeater device to receive the message for updating the SCI, the second indication being comprised in dedicated control information with cyclic redundancy check (CRC) scrambled by paging radio network temporary identity (P-RNTI), on a physical downlink shared channel (PDSCH), or a third indication for indicating the repeater device to receive the message for updating the SCI, the third indication being comprised in a paging message.

In some embodiments, the first indication is comprised in a field of PEI in the dedicated control information with CRC scrambled by PEI-RNTI.

In some embodiments, the second indication is comprised in a field of short message in the dedicated control information with CRC scrambled by P-RNTI.

In some embodiments, the third indication is comprised in a field for indicating a paging cause.

In some embodiments, the SCI is associated with at least one of the following: an access link between the repeater device and the terminal device, or a backhaul link between the repeater device and the network device.

In an aspect, a method of communication comprises: detecting, at a repeater device, a beam failure on a control link between the repeater device and a network device; and during a beam failure recovery (BFR), determining a forwarding function of the repeater device to be OFF.

In some embodiments, configuring the forwarding function of the repeater device to be OFF comprises: configuring the forwarding function of the repeater device to be OFF if at least one of the following: a beam for a backhaul link between the repeater device and the network device is the same with a beam of the control link; a transmission configuration indication (TCI) state set for the backhaul link is a subset of a TCI state set for the control link; or the backhaul link and the control link are operated in a same frequency resource.

In some embodiments, the method further comprises: after the BFR is successfully completed, determining the forwarding function of the repeater device to be ON or OFF according to previously received side control information (SCI) from the network device.

In an aspect, a method of communication comprises: receiving, at a repeater device and from a network device, a configuration indicating resources to be used for a communication between the repeater device and a terminal device; receiving, from the network device, a radio resource control (RRC) release message for transitioning the repeater device into an inactive state; after transitioning into the inactive state, performing at least one of the following: in case that the resources are periodic resources, maintaining availability of the resources; or in case that the resources are aperiodic resources, maintaining the availability of the resources or invaliding the resources.

In an aspect, a method of communication comprises: receiving, at a repeater device and from a network device, a radio resource control (RRC) release message for transitioning the repeater device into an inactive state; and determining a backhaul beam for a backhaul link between the repeater device and the network device based on a control beam for a control link between the repeater device and the network device, the control beam being indicated by the RRC release or determined by the repeater device.

In some embodiments, the method further comprises: determining a forwarding function of the repeater device to be ON or OFF according to previously received side control information (SCI) from the network device in case that the backhaul beam is available.

In an aspect, a method of communication comprises: transmitting, at a network device, to a repeater device, a radio resource control (RRC) release message for transitioning the repeater device into an inactive state; and transmitting, to the repeater device, a message for updating side control information (SCI) to be used by the repeater device in the inactive state.

In some embodiments, the message for updating the SCI is one of the following: an RRC release message, an RRC resume message, a mobile terminated (MT) small data transmission (SDT), a paging message, a dedicated control information with cyclic redundancy check (CRC) scrambled by paging radio network temporary identity (P-RNTI), a dedicated control information with CRC scrambled by paging early indication (PEI) RNTI (PEI-RNTI).

In some embodiments, the method further comprises: prior to transmitting the message for updating the SCI from the network device, receiving, from the repeater device, an RRC resume request message for requesting to update the SCI, the RRC resume request message being transmitted by the repeater device in response to an expiry of a timer for updating the SCI.

In some embodiments, the RRC resume request message comprises a resume cause for updating the SCI.

In some embodiments, the timer is a dedicated timer configured for updating the SCI, or the timer is a timer for updating a radio access network (RAN) notification area (RNA) which is reused for updating the SCI.

In some embodiments, a granularity unit of the timer is one of second or millisecond.

In some embodiments, the RRC release message comprises a configuration of the timer.

In some embodiments, the method further comprises: prior to transmitting the message for updating the SCI from the network device, transmitting one of the following: during a paging early indication (PEI) occasion, a first indication for indicating the repeater device to receive the message for updating the SCI, the first indication being comprised in a dedicated control information with CRC scrambled by PEI-RNTI, during a paging occasion, a second indication for indicating the repeater device to receive the message for updating the SCI, the second indication being comprised in dedicated control information with cyclic redundancy check (CRC) scrambled by paging radio network temporary identity (P-RNTI), on a physical downlink shared channel (PDSCH), or a third indication for indicating the repeater device to receive the message for updating the SCI, the third indication being comprised in a paging message.

In some embodiments, the first indication is comprised in a field of PEI in the dedicated control information with CRC scrambled by PEI-RNTI.

In some embodiments, the second indication is comprised in a field of short message in the dedicated control information with CRC scrambled by P-RNTI.

In some embodiments, the third indication is comprised in a field for indicating a paging cause.

In some embodiments, the SCI is associated with at least one of the following: an access link between the repeater device and the terminal device, or a backhaul link between the repeater device and the network device.

In an aspect, a method of communication comprises: generating, at a network device, a radio resource control (RRC) release message for transitioning a repeater device into an inactive state, the RRC release message indicating at least one beam to be used by the repeater device in case that the repeater device is in the inactive state; and transmitting, the RRC release message to the repeater device.

In an aspect, a repeater device comprises: at least one processor; and at least one memory coupled to the at least one processor and storing instructions thereon, the instructions, when executed by the at least one processor, causing the device to perform the method implemented by the repeater device discussed above.

In an aspect, a network device comprises: at least one processor; and at least one memory coupled to the at least one processor and storing instructions thereon, the instructions, when executed by the at least one processor, causing the device to perform the method implemented by the network device discussed above.

In an aspect, a computer readable medium having instructions stored thereon, the instructions, when executed on at least one processor, causes the at least one processor to perform the method implemented by the repeater device discussed above.

In an aspect, a computer readable medium having instructions stored thereon, the instructions, when executed on at least one processor, causes the at least one processor to perform the method implemented by the network device discussed above.

In an aspect, a computer program comprising instructions, the instructions, when executed on at least one processor, causes the at least one processor to perform the method implemented by the repeater device discussed above.

In an aspect, a computer program comprising instructions, the instructions, when executed on at least one processor, causes the at least one processor to perform the method implemented by the network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A repeater device comprising:
a processor configured to cause the repeater device to:
receive, from a network device, a radio resource control (RRC) release message for transitioning the repeater device into an inactive state;
receive, from the network device, a message for updating side control information (SCI) to be used by the repeater device in the inactive state; and
perform a communication with at least one of the network device or a terminal device by using the updated SCI.

2. The device of claim 1, wherein the message for updating the SCI is one of the following:
the RRC release message,
an RRC resume message,
a mobile terminated (MT) small data transmission (SDT),
a paging message,
a dedicated control information with cyclic redundancy check (CRC) scrambled by paging radio network temporary identity (P-RNTI), or
a dedicated control information with CRC scrambled by paging early indication (PEI) RNTI (PEI-RNTI).

3. The device of claim 1, wherein the processor is further configured to cause the repeater device to:
prior to receiving the message for updating the SCI from the network device, in response to an expiry of a timer for updating the SCI, transmit, to the network device, an RRC resume request message for requesting to update the SCI.

4. The device of claim 3, wherein the RRC resume request message comprises a resume cause for updating the SCI.

5. The device of claim 3, wherein the timer is a dedicated timer configured for updating the SCI, or
the timer is a timer for updating a radio access network (RAN) notification area (RNA) which is reused for updating the SCI.

6. The device of claim 3, wherein a granularity unit of the timer is one of second or millisecond.

7. The device of claim 3, wherein the RRC release message comprises a configuration of the timer.

8. The device of claim 1, wherein the processor is further configured to cause the repeater device to:
prior to receiving the message for updating the SCI from the network device, detect one of the following:
during a paging early indication (PEI) occasion, a first indication for indicating the repeater device to receive the message for updating the SCI, the first indication being comprised in a dedicated control information with CRC scrambled by PEI-RNTI,
during a paging occasion, a second indication for indicating the repeater device to receive the message for updating the SCI, the second indication being comprised in dedicated control information with cyclic redundancy check (CRC) scrambled by paging radio network temporary identity (P-RNTI), or
on a physical downlink shared channel (PDSCH), a third indication for indicating the repeater device to receive the message for updating the SCI, the third indication being comprised in a paging message.

9. The device of claim 8, wherein the first indication is comprised in a field of PEI in the dedicated control information with CRC scrambled by PEI-RNTI.

10. The device of claim 8, wherein the second indication is comprised in a field of short message in the dedicated control information with CRC scrambled by P-RNTI.

11. The device of claim 8, wherein the third indication is comprised in a field for indicating a paging cause.

12. The device of claim 1, wherein the SCI is associated with at least one of the following:
an access link between the repeater device and the terminal device, or a backhaul link between the repeater device and the network device.

13. A repeater device comprising:
a processor configured to cause the repeater device to:
detect a beam failure on a control link between the repeater device and a network device; and
during a beam failure recovery (BFR), determine a forwarding function of the repeater device to be OFF.

14. The device of claim 13, wherein configuring the forwarding function of the repeater device to be OFF comprises:
configuring the forwarding function of the repeater device to be OFF if at least one of the following:
a beam for a backhaul link between the repeater device and the network device is the same with a beam of the control link;
a transmission configuration indication (TCI) state set for the backhaul link is a subset of a TCI state set for the control link; or
the backhaul link and the control link are operated in a same frequency resource.

15. The device of claim 13, wherein the processor is further configured to cause the repeater device to:
after the BFR is successfully completed, determine the forwarding function of the repeater device to be ON or OFF according to previously received side control information (SCI) from the network device.

16. A repeater device comprising:
a processor configured to cause the repeater device to:
receive, from a network device, a configuration indicating resources to be used for a communication between the repeater device and a terminal device;
receive, from the network device, a radio resource control (RRC) release message for transitioning the repeater device into an inactive state; and
after transitioning into the inactive state, perform at least one of the following:
in case that the resources are periodic resources, maintaining availability of the resources; or
in case that the resources are aperiodic resources, maintaining the availability of the resources or invaliding the resources.

17-20. (canceled)
